(19) United States
(12) Patent Application Publication
(10) Pub. No.: US 2021/0189572 A1
(43) Pub. Date: Jun. 24, 2021

(54) PRODUCTION AND SEPARATION OF PHOSGENE BY MEANS OF A COMBINED CO2 AND CHLORIDE ELECTROLYSIS

(71) Applicant: Siemens Aktiengesellschaft, Munich (DE)

(72) Inventors: Bernhard Schmid, Duren (DE); Christian Reller, Minden (DE); Günter Schmid, Hemhofen (DE)

(73) Assignee: Siemens Aktiengesellschaft, Munich (DE)

(21) Appl. No.: 16/755,000

(22) PCT Filed: Sep. 21, 2018
(86) PCT No.: PCT/EP2018/075557

§ 371 Date: Apr. 9, 2020

(30) Foreign Application Priority Data
Nov. 9, 2017 (DE) 10 2017 219 974.1

(51) Int. Cl. C25B 1/26; C01B 32/40; C01B 32/80; C01B 7/04; C01B 32/50; C25B 9/19; C25B 15/08

(52) U.S. Cl. CPC C25B 1/26; C01B 32/40; C01B 32/80; C25B 15/08; C01B 32/50; C25B 9/19; C01B 7/04

(57) ABSTRACT

A method for producing phosgene directly from the directly combined raw products, preferably only dried raw products, of a combined CO₂ chloride electrolysis. A first gaseous product of CO is produced from CO₂ on the cathode side in at least one electrolysis cell for a CO₂ conversion into CO, and a second gaseous product of at least Cl₂ is produced from HCl and/or a metal chloride on the anode side, wherein phosgene is produced from the gaseous products.

### CROSS REFERENCE TO RELATED APPLICATIONS

This application is the US National Stage of International Application No. PCT/EP2018/075557 filed 21 Sep. 2018, and claims the benefit thereof. The International Application claims the benefit of German Application No. DE 10 2017 219 974.1 filed 9 Nov. 2017. All of the applications are incorporated by reference herein in their entirety.

### FIELD OF INVENTION

The present invention relates to a process for preparing phosgene directly from the directly combined crude products, advantageously having merely been dried, of a combined CO₂-chloride electrolysis. This involves preparing a first gaseous product comprising CO from CO₂ on the cathode side in at least one electrolysis cell for CO₂ conversion to CO, and preparing a second gaseous product comprising at least Cl₂ from HCl and/or a metal chloride on the anode side, and preparing phosgene from these.

In this process, a costly individual separation of the individual gas streams from the half-cells is dispensed with. Instead, these are combined and reacted. Subsequently, the high boiling point of the phosgene is exploited for an inexpensive and economic product separation.

### BACKGROUND OF INVENTION

Phosgene (COCl₂) is a chemical commodity having multiple possible uses. It is required, inter alia, for preparation of polycarbonates and isocyanates, and for polyurethanes and polyureas. Phosgene is usually synthesized by reaction of carbon monoxide (CO) with elemental chlorine (Cl₂). The reaction can be initiated by light, but it is generally performed under catalysis by activated carbon.

The CO required for the purpose has to date been prepared from fossil fuels by Steam reforming: CH₄+H₂O→CO+3H₂; Coal gasification: C+H₂O→CO+H₂; or Partial coal combustion: 2C+O₂→2CO.

Coal combustion additionally also serves to generate energy. The combustion of fossil fuels currently covers about 80% of global energy demand. These combustion processes emitted about 34 032.7 million metric tons of carbon dioxide (CO₂) globally into the atmosphere in 2011. This release is the simplest way of disposing of even large volumes of CO₂ (brown coal power plants exceeding 50 000 t per day).

Discussion about the adverse effects of the greenhouse gas CO₂ on the climate has led to consideration of reutilization of CO₂. In thermodynamic terms, CO₂ is at a very low level and can therefore be reduced again to usable products only with difficulty.

The electrochemical reduction of CO₂ at solid-state electrodes in aqueous electrolyte solutions offers a multitude of possible products that are shown in table 1 below, taken from Y. Hori, Electrochemical CO₂ reduction on metal electrodes, in: C. Vayenas, et al. (eds.), Modern Aspects of Electrochemistry, Springer, New York, 2008, p. 89-189.

TABLE 1
Faraday efficiencies in the electrolysis of CO₂ over
various electrode materials

| Electrode | CH₄ | C₂H₄ | C₂H₅OH | C₃H₇OH | CO | HCOO⁻ | H₂ | Total |
|---|---|---|---|---|---|---|---|---|
| Cu | 33.3 | 25.5 | 5.7 | 3.0 | 1.3 | 9.4 | 20.5 | 103.5 |
| Au | 0.0 | 0.0 | 0.0 | 0.0 | 87.1 | 0.7 | 10.2 | 98.0 |
| Ag | 0.0 | 0.0 | 0.0 | 0.0 | 81.5 | 0.8 | 12.4 | 94.6 |
| Zn | 0.0 | 0.0 | 0.0 | 0.0 | 79.4 | 6.1 | 9.9 | 95.4 |
| Pd | 2.9 | 0.0 | 0.0 | 0.0 | 28.3 | 2.8 | 26.2 | 60.2 |
| Ga | 0.0 | 0.0 | 0.0 | 0.0 | 23.2 | 0.0 | 79.0 | 102.0 |
| Pb | 0.0 | 0.0 | 0.0 | 0.0 | 0.0 | 97.4 | 5.0 | 102.4 |
| Hg | 0.0 | 0.0 | 0.0 | 0.0 | 0.0 | 99.5 | 0.0 | 99.5 |
| In | 0.0 | 0.0 | 0.0 | 0.0 | 2.1 | 94.9 | 3.3 | 100.3 |
| Sn | 0.0 | 0.0 | 0.0 | 0.0 | 7.1 | 88.4 | 4.6 | 100.1 |
| Cd | 1.3 | 0.0 | 0.0 | 0.0 | 13.9 | 78.4 | 9.4 | 103.0 |
| Tl | 0.0 | 0.0 | 0.0 | 0.0 | 0.0 | 95.1 | 6.2 | 101.3 |
| Ni | 1.8 | 0.1 | 0.0 | 0.0 | 0.0 | 1.4 | 88.9 | 92.4 |
| Fe | 0.0 | 0.0 | 0.0 | 0.0 | 0.0 | 0.0 | 94.8 | 94.8 |
| Pt | 0.0 | 0.0 | 0.0 | 0.0 | 0.0 | 0.1 | 95.7 | 95.8 |
| Ti | 0.0 | 0.0 | 0.0 | 0.0 | 0.0 | 0.0 | 99.7 | 99.7 |

The table states Faraday efficiencies [%] of products formed in carbon dioxide reduction at various metal electrodes. The values reported are applicable to a 0.1 M potassium hydrogencarbonate solution as electrolyte and current densities below 10 mA/cm².

There are currently discussions about the electrification of the chemical industry. This means that chemical commodities or fuels are to be produced advantageously from CO₂ (CO), H₂O with supply of surplus electrical energy, advantageously from renewable sources. In the phase of introduction of such technology, the aim is for the economic value of a substance to be significantly greater than its calorific value. For example, it is possible here to produce the CO required for phosgene synthesis at a cathode.

In addition, chlorine is currently obtained by anodic oxidation of chlorides. Originally, hydrogen was always produced here at the cathode (see, for example, eqs. 1.1+1.2).

2HCl→H₂+Cl₂ (1.1)

2NaCl+H₂O→2NaOH+H₂+Cl₂ (1.2)

A more recent development is the use of what are called oxygen-depolarized cathodes, wherein oxygen rather than water is reduced at the cathode, which leads to a lower overall voltage (see, for example, eqs. 2.1+2.2).

4HCl+O₂→2H₂O+2Cl₂ (2.1)

4NaCl+2H₂O+O₂→4NaOH+2H₂O+2Cl₂ (2.2)

Oxygen-depolarized cathodes are what are called gas diffusion electrodes. These are porous electrodes that can be penetrated by the reaction gas (O₂ in this case) and hence are capable of providing three-phase boundaries (gas, electrolyte, electrode) at which a desired reaction can take place. It is thus possible to achieve significantly higher current densities than when the reaction gas is physically dissolved in the electrolyte.

However, gas diffusion electrode technology is not limited to the reduction of oxygen. CO₂ reduction to CO, for example, can also be conducted at a gas diffusion electrode.

With CO and Cl₂, it is thus possible to prepare both reactants required for phosgene preparation electrochemically. In existing phosgene preparation according to the prior art, however, the components required for the preparation are provided and purified separately, which can be associated with extra apparatus complexity and energy expenditure.

There is therefore a need for an efficient and simple process for preparation of phosgene.

### SUMMARY OF INVENTION

The basic idea of the invention is that such a CO₂ electrolysis takes place at the cathode and the evolution of chlorine at the anode, the processes can be combined, and phosgene can be prepared and separated from the product gases in a simple manner. This results in the following overall equations:

CO₂+2HCl→CO+H₂O+Cl₂ (3.1)

3CO₂+H₂O+2KCl→CO+2KHCO₃+KCl (3.2)

The inventors have now found that mixtures of the gases CO₂, Cl₂, H₂, HCl and COCl₂ can be separated much more easily and hence at lesser expense than mixtures of H₂, CO and CO₂.

In a first aspect, the present invention relates to a process for preparing phosgene, wherein i) a first gaseous product comprising CO is prepared from CO₂ on the cathode side in at least one electrolysis cell for CO₂ conversion to CO, and a second gaseous product comprising at least Cl₂ is prepared from HCl and/or a metal chloride, where the HCl and/or the metal chloride are optionally in the form of a solution, on the anode side; ii) the first gaseous product and the second gaseous product are combined in order to produce a product gas mixture; iii) the product gas mixture is reacted at least to give phosgene, in order to prepare a reacted product gas mixture; and iv) phosgene is separated from the reacted product gas mixture.

A further aspect of the invention relates to an apparatus for preparation of phosgene, comprising: —at least one electrolysis cell for CO₂ conversion to CO, comprising a cathode space comprising a cathode for CO₂ conversion to a first gaseous product comprising CO, said cathode being set up to convert CO₂ to a first gaseous product comprising CO, and an anode space comprising an anode for conversion of HCl and/or metal chloride, where the HCl and/or the metal chloride are optionally in the form of a solution, to a second gaseous product comprising at least Cl₂, said anode being set up to convert HCl and/or a metal chloride, where the HCl and/or the metal chloride are optionally in the form of a solution, to a second gaseous product comprising at least Cl₂, —at least one first feed apparatus for CO₂ which is connected to the cathode space of the electrolysis cell for CO₂ conversion to CO and is set up to feed CO₂ to the cathode space of the electrolysis cell for CO₂ conversion to CO, —at least one second feed apparatus for HCl and/or a metal chloride, where the HCl or the metal chloride is optionally in the form of a solution, which is connected to the anode space of the electrolysis cell for CO₂ conversion to CO and is set up to feed HCl and/or a metal chloride, where the HCl or the metal chloride is optionally in the form of a solution, to the anode space of the electrolysis cell for CO₂ conversion to CO, —at least one first removal apparatus for the first gaseous product which is connected to the cathode space of the electrolysis cell for CO₂ conversion to CO and is set up to remove the first gaseous product from the cathode space of the electrolysis cell for CO₂ conversion to CO, —at least one second removal apparatus for the second gaseous product which is connected to the anode space of the electrolysis cell for CO₂ conversion to CO and is set up to remove the second gaseous product from the anode space of the electrolysis cell for CO₂ conversion to CO, —at least one first combining apparatus which is connected to the first removal apparatus and the second removal apparatus and is set up to combine the first gaseous product and the second gaseous product in order to produce a product gas mixture; —at least one first reactor which is connected to the first combining apparatus and is set up to react the product gas mixture at least to give phosgene, in order to prepare a reacted product gas mixture; and —at least one first separation apparatus which is connected to the first reactor and is set up to separate phosgene from the reacted product gas mixture;

or comprising—at least one electrolysis cell for CO₂ conversion to CO, comprising a cathode space comprising a cathode for CO₂ conversion to a first gaseous product comprising CO, said cathode being set up to convert CO₂ to a first gaseous product comprising CO, and an anode space comprising an anode for conversion of HCl and/or metal chloride, where the HCl and/or the metal chloride are optionally in the form of a solution, to a second gaseous product comprising at least Cl₂, said anode being set up to convert HCl and/or a metal chloride, where the HCl and/or the metal chloride are optionally in the form of a solution, to a second gaseous product comprising at least Cl₂, —at least one first feed apparatus for CO₂ which is connected to the cathode space of the electrolysis cell for CO₂ conversion to CO and is set up to feed CO₂ to the cathode space of the electrolysis cell for CO₂ conversion to CO, —at least one second feed apparatus for HCl and/or a metal chloride, where the HCl or the metal chloride is optionally in the form of a solution, which is connected to the anode space of the electrolysis cell for CO₂ conversion to CO and is set up to feed HCl and/or a metal chloride, where the HCl or the metal chloride is optionally in the form of a solution, to the anode space of the electrolysis cell for CO₂ conversion to CO, —at least one common removal apparatus for the first gaseous product and the second gaseous product which is connected to the electrolysis cell for CO₂ conversion to CO and is set up to remove the first gaseous product and the second gaseous product from the electrolysis cell for CO₂ conversion to CO, —at least one first reactor which is connected to the common removal apparatus and is set up to react the product gas mixture at least to give phosgene, in order to prepare a reacted product gas mixture; and —at least one first separation apparatus which is connected to the first reactor and is set up to separate phosgene from the reacted product gas mixture.

More particularly, it is possible to use the apparatus of the invention to perform the process of the invention.

Further aspects of the present invention can be found in the dependent claims and the detailed description.

### BRIEF DESCRIPTION OF THE DRAWINGS

The appended drawings are intended to illustrate embodiments of the present invention and impart further understanding thereof. In association with the description, they serve to explain concepts and principles of the invention. Other embodiments and many of the advantages mentioned are apparent with regard to the drawings. The elements of the drawings are not necessarily shown true to scale relative to one another. Elements, features and components that are the same, have the same function and the same effect are each given the same reference numeral in the figures of the drawings unless stated otherwise.

FIGS. 1 to 12 show possible sequences in schematic form in a process of the invention.

FIGS. 13 to 19 show, in schematic form, arrangements of electrolysis cells with feed and removal devices that can be employed in a process of the invention and in an apparatus of the invention.

### DETAILED DESCRIPTION OF INVENTION

### Definitions

Unless defined otherwise, technical and scientific expressions used herein have the same meaning as commonly understood by a person skilled in the art in the specialist field of the invention.

The invention relates, in a first aspect, to a process for preparing phosgene, wherein i) a first gaseous product comprising CO is prepared from CO₂ on the cathode side in at least one electrolysis cell for CO₂ conversion to CO, and a second gaseous product comprising at least Cl₂ is prepared from HCl and/or a metal chloride, where the HCl and/or the metal chloride are optionally in the form of a solution, on the anode side; ii) the first gaseous product and the second gaseous product are combined in order to produce a product gas mixture; iii) the product gas mixture is reacted at least to give phosgene, in order to prepare a reacted product gas mixture; and iv) phosgene is separated from the reacted product gas mixture.

In the process of the invention, steps i) to iv) run sequentially in that sequence. In a process of the invention, the CO and Cl₂ required for phosgene preparation are thus generated in a first step in the same plant. The gases generated in the at least one electrolysis cell, for example in an electrolyzer, may optionally be dried and then mixed directly in order to produce a product gas mixture, and reacted in order to produce a reacted product gas mixture. Subsequently, the reacted product gas mixture thus obtained is separated in such a way that at least phosgene is separated off. In particular embodiments, the product gas mixture and/or the reacted product gas mixture, however, are separated further, advantageously completely. In this case, the individual constituents of the product gas mixture and/or of the reacted product gas mixture can be separated off at variable times, for example depending on whether the product gas mixture is also reacted to give HCl. It is thus possible for gas constituents to be separated off before the reaction to give phosgene and/or after the reaction to give phosgene.

In the process of the invention, a step i) takes place first, wherein a first gaseous product comprising CO is prepared from CO₂ on the cathode side in at least one electrolysis cell for CO₂ conversion to CO, and a second gaseous product comprising at least Cl₂ is prepared from HCl and/or a metal chloride, where the HCl and/or the metal chloride are optionally in the form of a solution, on the anode side.

The first step here is not particularly restricted, provided that preparation of both CO from CO₂ and of Cl₂ from HCl and/or a metal chloride is possible in the at least one electrolysis cell. It is also possible for multiple electrolysis cells to be present, in which CO and Cl₂ are prepared at the same time. It is also possible that there are additionally also electrolysis cells present in which CO only is prepared at a cathode or Cl₂ only at an anode, in which case there is no restriction in the corresponding anode or cathode reaction. Such additional electrolysis cells can be used, for example, to add a product gas comprising CO from a cathode or a product gas comprising Cl₂ from an anode of such an additional electrolysis cell to the product gas mixture from the at least one electrolysis cell, in order to establish a suitable stoichiometry in the conversion to phosgene.

It is of course also or alternatively possible to achieve a suitable stoichiometry for conversion of phosgene by suitably controlling the reactions at the anode and/or cathode in the at least one electrolysis cell in the process of the invention, in order to achieve this suitable stoichiometry. It is possible here, for example, to suitably adjust reactant streams for the cathode and/or anode, the cathode and/or anode material, currents, etc.

Nor is it impossible that H₂ is additionally prepared as a by-product at the cathode and/or anode, and can then be taken into account correspondingly in the subsequent reaction and purification of the product gas mixture.

It is likewise unnecessary for complete conversion to be effected at the anode and cathode. For example, unconverted CO₂ may remain even in the first gaseous product from the cathode, since this does not disrupt the conversion to phosgene. Since CO₂ cannot be further oxidized by chlorine, it is unproblematic in the preparation of phosgene.

Correspondingly, in the case of CO₂ electrolysis, the first gaseous product at the cathode may contain not just CO but also hydrogen from a competing water reduction—for example when aqueous electrolytes are used—and/or unconverted CO₂.

It is likewise not impossible that gases are transferred from the anode side to the cathode side and/or gases from the cathode side to the anode side. For example, CO₂, including after not having reacted, can be transferred to the anode side and be present in the second gaseous product.

For example, the second product gas on the anode side may optionally, as well as Cl₂, include unconverted CO₂ from the cathode side.

In particular embodiments, however, the first gaseous product on the cathode side and the second gaseous product on the anode side are separated, for example by means of at least one membrane and/or at least one diaphragm in the at least one electrolysis cell, in such a way that these essentially do not mix or, at most, CO₂ gets into the second gaseous product. In this way, it is possible to avoid formation of a reactive mixture in the electrolysis cell, for example of CO and Cl₂ and/or especially H₂ (from a cathodic side reaction) and Cl₂—i.e. of an explosive chlorine/oxyhydrogen mixture. Illustrative embodiments of membranes and/or diaphragms in the at least one electrolysis cell are elucidated hereinafter in relation to the apparatus of the invention, but may also be employed correspondingly in the process of the invention, and so reference is made to these specific embodiments here too.

For the conversion of CO₂ to CO and of HCl and/or metal chloride to Cl₂, the respective electrode material is not particularly restricted, provided that the respective reaction can proceed correspondingly. Thus, anode and cathode in the at least one electrolysis cell are not particularly restricted, provided that the cathode is suitable for electrochemical conversion of gaseous CO₂ to CO, and the anode is suitable for electrochemical oxidation of chloride to chlorine, especially in solutions of hydrogen chloride or metal chlorides such as alkali metal chlorides, especially aqueous solutions. In particular embodiments, the first gaseous product and/or the second gaseous product is prepared with a gas diffusion electrode.

Possible embodiments a cathode are, for example, a silver- and/or gold-based gas diffusion electrode, a gas diffusion electrode of a composite of silver and/or gold with an anion exchange membrane (AEM), a silver particle-laden carbon gas diffusion layer, an open sheetlike structure made of silver or gold, a silver- and/or gold-based coating on an AEM, cation exchange membrane (CEM) or a diaphragm, etc.

Possible embodiments of the anode are, for example, an open sheetlike structure composed, for example, of titanium coated with a catalyst, a catalyst-laden or -impregnated carbon gas diffusion layer, a catalyst coating on an AEM or CEM or a diaphragm, etc., with examples of suitable catalysts including IrOₓ, RuO₂, or mixed oxides thereof, optionally also with addition of TiO₂, etc.

Within the at least one electrolysis cell, it is possible to use at least one electrolyte. When a cathode space and an anode space or further spaces are separated by at least one membrane and/or one diaphragm, it is also possible for multiple electrolytes to be present in the at least one electrolysis cell. These may be the same or different and are not particularly restricted. In particular embodiments, one or more aqueous electrolytes are used. These may optionally include a conductive salt which is not particularly restricted. Especially on the anode side, if a metal chloride is used there in the electrolysis, this can also serve as conductive salt. Alternatively or additionally, it is of course also possible for HCl to be present in the form of hydrochloric acid on the anode side, but this may also be supplied as gas, for example in a gas diffusion electrode.

The metal chloride on the anode side is not particularly restricted, provided that this can be used to prepare chlorine by electrolysis. In particular embodiments, the metal chloride is an alkali metal chloride, e.g. LiCl, NaCl, KCl, RbCl, CsCl, and/or mixtures thereof. It is not impossible that further metal chlorides and/or conductive salts including acids and bases are present on the anode side.

In a second step ii), the first gaseous product and the second gaseous product are combined in order to produce a product gas mixture. This is not particularly restricted, and can be effected within or outside the at least one electrolysis cell, but is advantageously effected outside, for example when at least one membrane and/or one diaphragm is provided in the at least one electrolysis cell.

It is also or additionally possible to achieve a separation of the first gaseous product and the second gaseous product in the at least one electrolysis cell by means of an appropriate adjustment of the flow directions on the cathode side and/or anode side, such that, in this way too, the first gaseous product and the second gaseous product are conducted separately out of the electrolysis cell and combined outside, but advantages are given to the separation of the first gaseous product and the second gaseous product within the at least one electrolysis cell by means of at least one membrane and/or one diaphragm. In particular embodiments, the electrolysis cell for CO₂ conversion to CO thus has a cathode space and an anode space that are separated by at least one membrane and/or one diaphragm. The membrane or the diaphragm here are not particularly restricted.

The manner of combining the first gaseous product and the second gaseous product, for example outside the at least one electrolysis cell, is not particularly restricted, and can be effected, for example, by means of at least one first combining apparatus, for example in the form of a T- or Y-piece or a similar conduit junction.

Prior to the combining of the first gaseous product and the second gaseous product, the first gaseous product and the second gaseous product can still be purified and/or dried. Drying in particular is an option in order to remove any entrained water, for example from an electrolyte. Since the first gaseous product and the second gaseous product are in any case mixed as crude gases, contamination of one of the two with the other is not harmful, also by contrast with most other applications. As a result, it is possible to make the apparatus simple, and it is especially also possible to avoid complicated membrane, diaphragm and/or flow arrangements.

In a step iii), the product gas mixture is reacted at least to give phosgene, in order to prepare a reacted product gas mixture.

The manner of reaction here is not particularly restricted. For example, it can be catalyzed, for example with activated carbon, in a suitable reactor that may be cooled, for example.

As already set out, for the reaction to give phosgene, a suitable stoichiometry of the product gas mixture may be assured by appropriate settings in the at least one electrolysis cell and/or optionally by additional supply of Cl₂ and/or CO. In particular embodiments, it is ensured in the phosgene preparation that CO and/or Cl₂ react very substantially and/or completely and/or Cl₂ remains in such an amount that it can additionally be converted, advantageously fully, to HCl.

In a step iv), phosgene is separated from the reacted product gas mixture. This is not particularly restricted and can suitably be performed irrespective of whether HCl, H₂ and/or HCl and/or unreacted CO₂ and/or CO and/or Cl₂ may be still present in the reacted product gas mixture. The phosgene can be separated very easily from the reacted product mixtures, especially on account of its high boiling point. Phosgene boils at 7° C., and therefore very mild cooling to 0° C., for example, is sufficient to remove it from the mixture. In particular embodiments, the phosgene is separated off at a temperature of 7° C. or lower, advantageously 5° or lower, for example 0° C. or lower. In particular embodiments, the phosgene is separated off at a temperature of −30° C. or higher, advantageously −20° C. or higher, further advantageously −10° C. or higher. The higher the temperature in the phosgene separation, the lower the likelihood of contamination with further gases.

If CO, H₂ and Cl₂ are prepared by electrolysis in the at least one electrolysis cell—i.e. H₂ is formed as by-product, for example at the cathode—the following stoichiometry, for example, is possible in the preparation of phosgene, meaning that HCl is additionally prepared, for example in a second reactor:

X Cl₂+Y CO+(X—Y)H₂→Y COCl₂+2*(X—Y)HCl

advantageously: Y/X>0.75
more advantageously: Y/X>0.9

Since a high hydrogen content is disadvantageous in this process, the Faraday efficiency, especially for CO at the cathode, should be at a maximum. One reason is the high energy release in the chlorine/hydrogen gas reaction.

In particular embodiments, HCl is additionally prepared from the product gas mixture, with preparation of the HCl before, with or after the preparation of the phosgene.

If HCl is additionally prepared in the process of the invention, it is advantageous to conduct the preparation of phosgene and the preparation of HCl in separate steps, i.e. HCl before or after the phosgene. In the H₂+2Cl₂+CO system, for example, the phosgene yield declines significantly on heating above 150° C. It is therefore also advantageous to allow the phosgene formation and the chlorine/hydrogen gas reaction to proceed in separate stages.

It is possible, for example, in particular embodiments to put the preparation of HCl before the actual phosgene synthesis, for example when the temperature is set high enough, e.g. above 150° C., e.g. above 200° C., in order to prevent phosgene formation.

Alternatively, in particular embodiments, Cl₂ and H₂ present in the reacted product gas mixture may be converted to HCl in a chlorine/hydrogen gas reaction after the preparation of phosgene.

Thus, if anode gas and cathode gas from a combined CO—Cl₂ electrolysis system in which H₂ also forms are mixed, and the mixture is reacted completely, the result is a mixture of COCl₂, CO₂ and HCl.

Subsequently, the HCl can be removed from the reacted product gas mixture, or, if the HCl is prepared before the preparation of phosgene, it can also be separated from the product gas mixture before the preparation of phosgene. This can be accomplished, for example, by scrubbing-out, for example with water, or by absorption, for example in KHCO₃ solution of any concentration in water, advantageously between 0.5-1.5 M. In the latter case, CO₂ is released with formation of KCl, both of which can be recycled back into the process of the invention. In particular embodiments, HCl is scrubbed out of the product gas mixture or the reacted product gas mixture. In particular embodiments, HCl is separated from the product gas mixture or the reacted product gas mixture by absorption in KHCO₃.

In particular embodiments, the preparation of HCl and the separation of HCl precede the preparation of phosgene. In this way, the apparatus complexity can be reduced further, especially since HCl can be separated off in a simple manner.

After a complete conversion to HCl and phosgene, it is especially possible to recycle the remaining pure CO₂ to the cathode of the at least one electrolysis cell. The KCl obtained in the separation of HCl or aqueous, especially dilute, HCl can also be recycled to the anode of the at least one electrolysis cell. The HCl can form, for example, as a by-product from a chemical process.

Alternatively, the CO₂ can also be separated, for example, by freezing-out or cryoadsorption. In that case, this method in particular does not afford dilute hydrochloric acid, but rather dry hydrogen chloride, which can be used, for example, for direct commercial utilization rather than for recycling into the electrolysis. In particular embodiments, CO₂ is thus separated from the reacted product gas mixture, especially by cryoadsorption or freezing-out.

If the product gas mixture is reacted only to give phosgene, i.e. no HCl is prepared, H₂ and Cl₂ can remain in the reacted product gas mixture. If the product gas mixture, for example, is guided solely through an activated carbon catalyst, the result is a mixture of COCl₂, CO₂, H₂ and Cl₂, where H₂ and Cl₂ may be present in a ratio of 1:1. As an alternative, it is thus also possible to leave out the chlorine/oxyhydrogen gas reaction, in which case a change in the separation change in the process of separating the gases of the gases in the reacted product gas mixture may be required. Especially on account of the stoichiometry resulting from the electrolysis, the gas mixture may then contain not only CO₂ but also equivalent amounts of H₂ and Cl₂. Since Cl₂ already condenses at −34° C., it can be separated off comparatively easily by cryodistillation (cryogenic distillation). In particular embodiments, Cl₂ can be separated out of the reacted product gas mixture by cryodistillation, for example at a temperature of −34° C. or less, advantageously −35° C. or less, further advantageously −40° C. or less. Alternatively, it is of course also possible to separate off chlorine in another way.

The H₂—CO₂ mixture remaining after a separation of Cl₂ can subsequently be separated by standard methods for CO₂ or H₂ separation, such as a membrane permeation, a pressurized water scrub, an amine scrub, a carbonate scrub, etc., according to the case of application. Advantage is given to recycling the CO₂ separated off to the electrolysis.

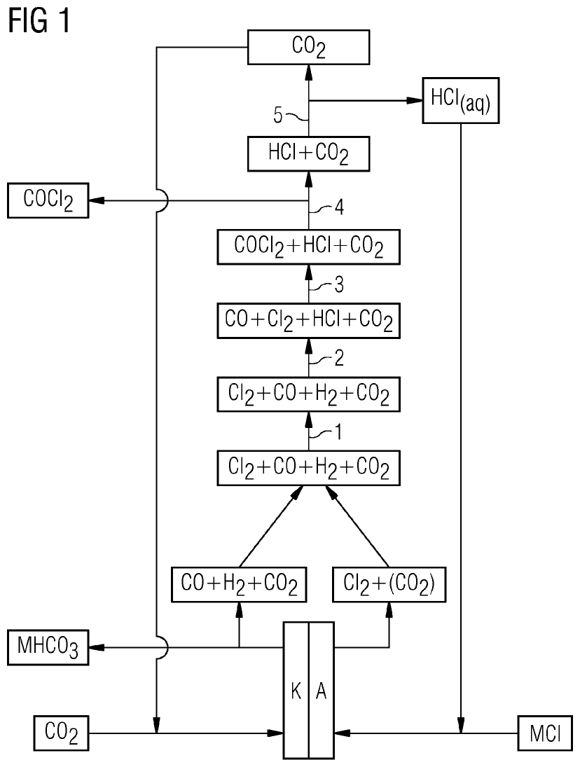

FIGS. 1 to 12 illustrate, in abstract and schematic form, various variants of the process of the invention described in detail above. In the figures, it is assumed here that H₂ forms as a by-product on the cathode side.

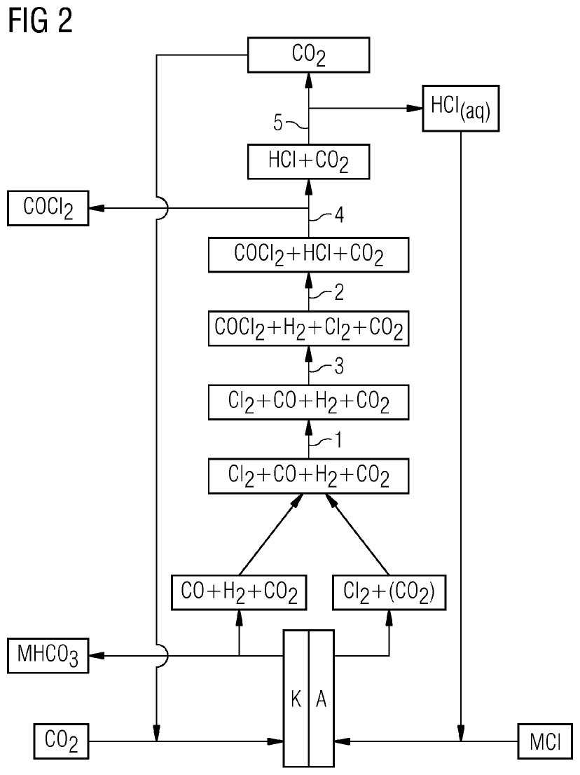

FIG. 1 and FIG. 2 show possible processes for an illustrative combined alkali metal chloride (MCl; M=alkali metal)-CO₂ electrolysis with complete conversion and HCl separation by scrubbing and chloride recycling.

FIG. 1 shows a variant in which HCl is prepared first before phosgene is prepared. In an electrolysis cell, a first gaseous product comprising CO, H₂ and unreacted CO₂ is first obtained here on the side of the cathode K from the electrolysis of CO₂. In addition, as a by-product, MHCO₃ with hydrogencarbonate ions formed, which can react with the electrolyte, is removed from the cathode space, if present. On the side of the anode A, a second gaseous product comprising Cl₂ and optionally CO₂ is obtained, which can get into the anode space. The two gaseous products leave the electrolysis cell separately from the respective electrode space and are combined outside in order to obtain a product gas mixture comprising Cl₂, CO, H₂ and CO₂. In a step 1, the product gas mixture obtained is dried before H₂ and Cl₂ are reacted in a step 2 in order to obtain a product gas mixture in which CO, Cl₂, HCl and CO₂ are present. In a reaction step 3, this product gas mixture is reacted, forming phosgene (COCl₂) from CO and Cl₂. Thus, a reacted product gas mixture comprising COCl₂, HCl and CO₂ is obtained. The phosgene is then separated therefrom in step 4 by cooling, for example at 5° C., such that a gas mixture comprising HCl and CO₂ remains. The HCl can be separated therefrom in step 5 as hydrochloric acid (HCl_{aq}) by scrubbing with water, and this can be recycled back to the anode space in order, for example, to prepare an alkali metal chloride solution again with a suitable metal salt. The remaining CO₂ can then be recycled to the cathode space.

The sequence in FIG. 2 corresponds for the most part to that of FIG. 1, except that step 2 of preparing HCl and step 3 of preparing phosgene have been switched.

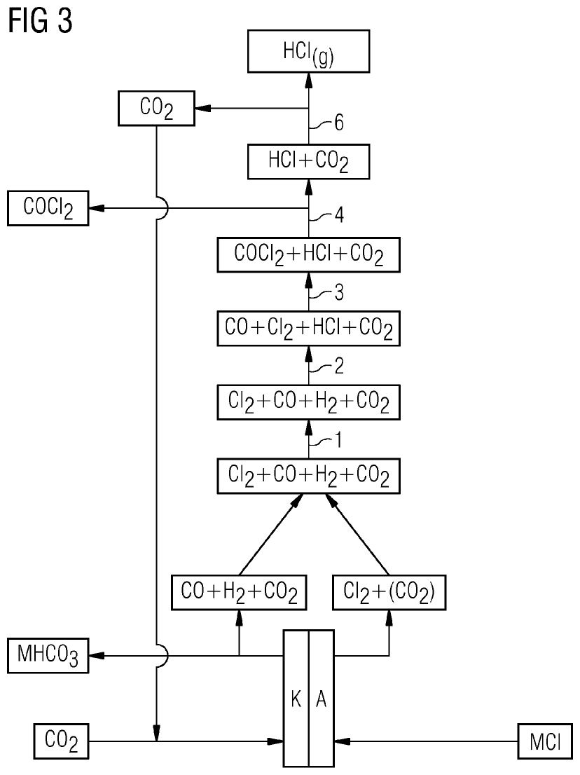

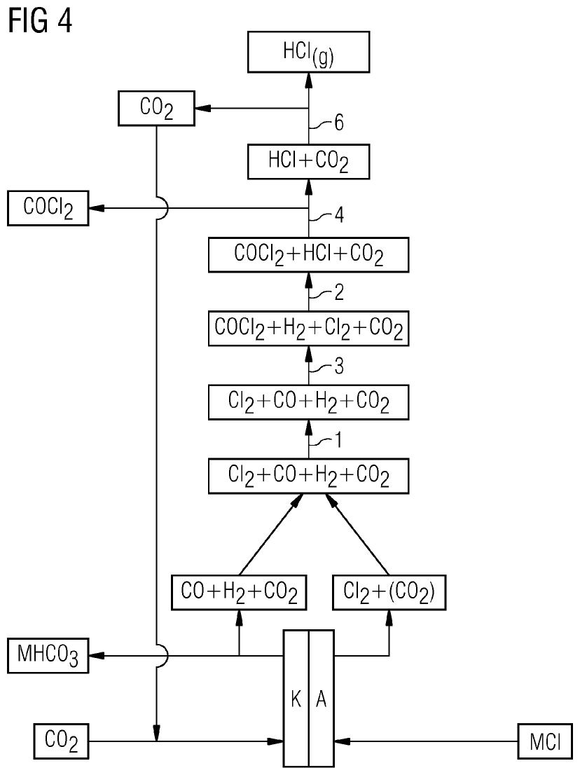

FIG. 3 and FIG. 4 show possible processes for an illustrative combined alkali metal chloride-CO₂ electrolysis with complete conversion and cryogenic separation of CO₂.

The sequence in FIG. 3 corresponds here for the most part to that of FIG. 1, with a step 6 of CO₂ separation by a cryoadsorption or freezing-out here instead of step 5. In this way, it is possible to obtain HCl as a gaseous material of value. The CO₂ can in turn be recycled.

The sequence in FIG. 4 corresponds again to that in FIG. 3 with an exchange of step 2 of preparing HCl and step 3 of preparing phosgene.

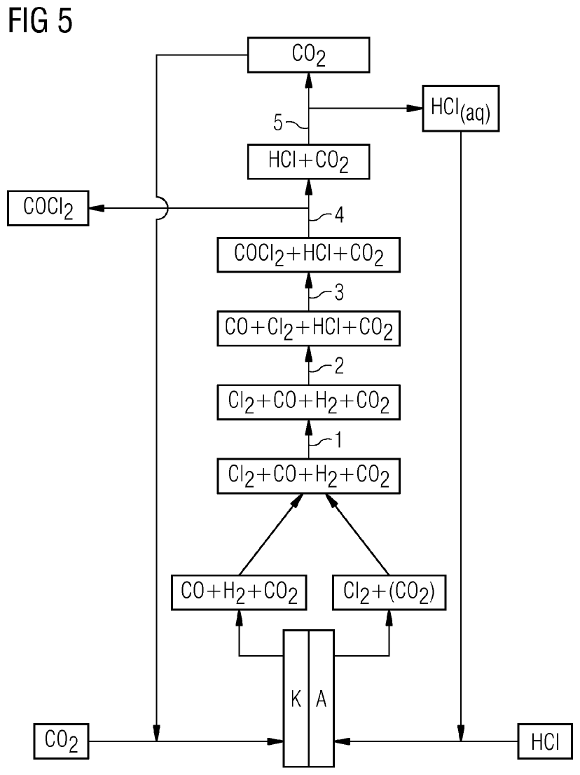

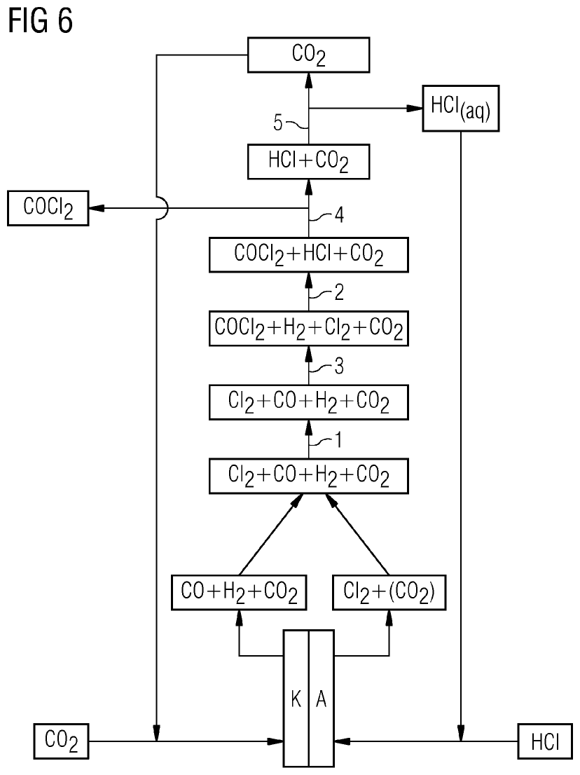

FIG. 5 and FIG. 6 show possible processes for a combined hydrochloric acid-CO₂ electrolysis with complete conversion and HCl separation by scrubbing and chloride recycling.

The sequence in FIG. 5 corresponds for the most part to that in FIG. 1, with addition of HCl rather than MCl to the anode space, optionally even in the form of hydrochloric acid. Hydrochloric acid can be formed in the anode space at least by an aqueous electrolyte present. Since no MCl is added, no MHCO₃ is formed according to FIG. 5. The further sequence corresponds to that of FIG. 1.

The sequence in FIG. 6 corresponds again to that in FIG. 5 with an exchange of step 2 of preparing HCl and step 3 of preparing phosgene.

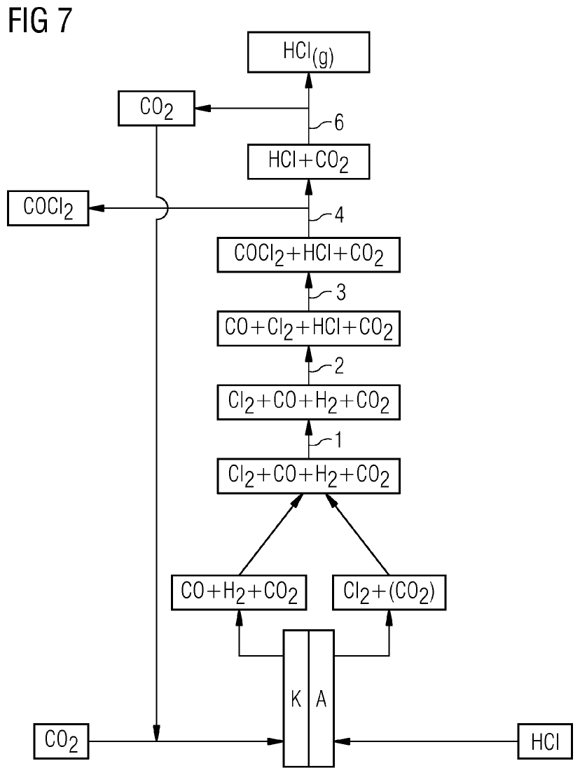

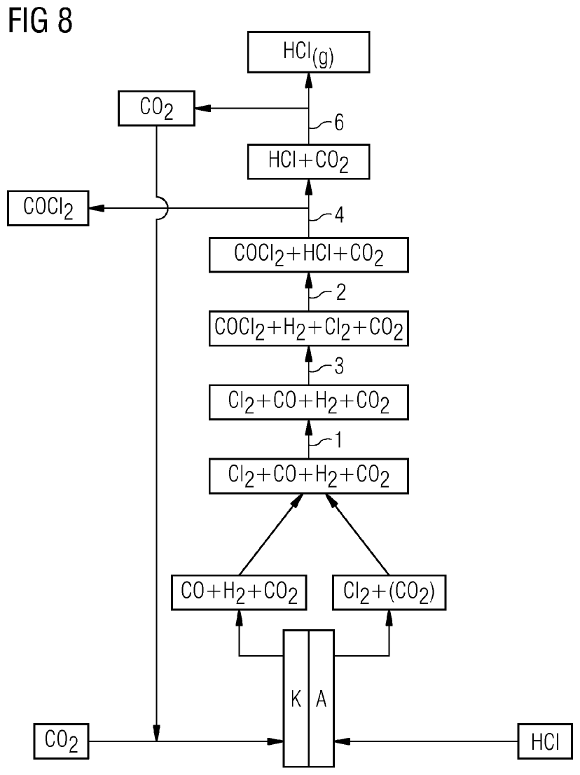

FIG. 7 and FIG. 8 show possible processes for a combined hydrochloric acid-CO₂ electrolysis with complete conversion and cryogenic CO₂ separation.

The sequence in FIG. 7 corresponds for the most part to that of FIG. 5, with, as in FIG. 3, a step 6 of CO₂ separation by a cryoadsorption or freezing-out conducted here instead of step 5.

The sequence in FIG. 8 corresponds again to that in FIG. 7 with an exchange of step 2 of preparing HCl and step 3 of preparing phosgene.

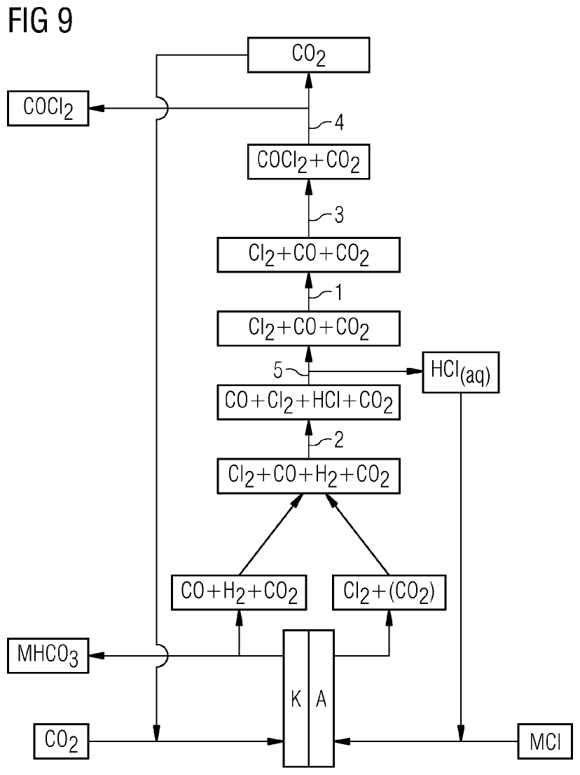

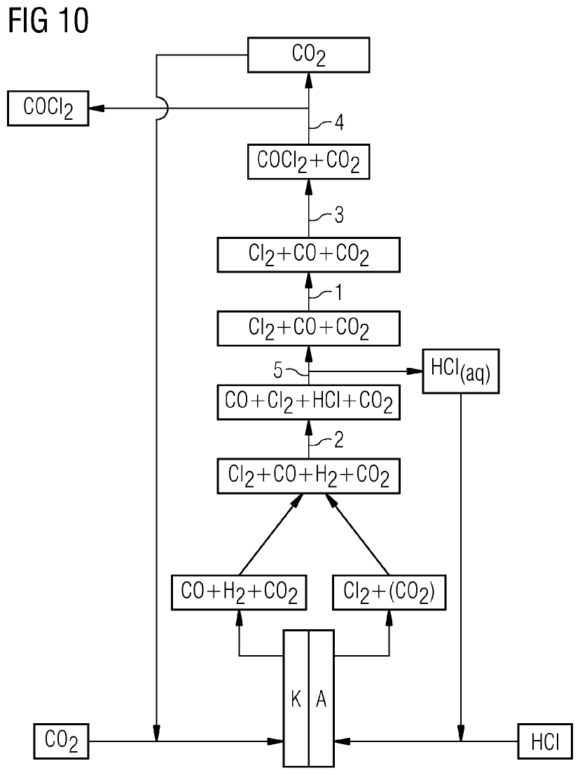

FIG. 9 and FIG. 10 show the option of putting the preparation of HCl and separation before the actual phosgene synthesis, for example when the temperature is set high enough to prevent phosgene formation.

FIG. 9 shows a possible process for a combined alkali metal chloride-CO₂ electrolysis with intermediate hydrochloric acid separation.

According to FIG. 9, as in FIG. 1, a product gas mixture is prepared. However, this is not dried at first; instead, a step 2 of preparing HCl takes place. The latter is then scrubbed out in a step 5, which is the reason why no drying was required beforehand. Only thereafter does a drying step 1 take place, which is followed by the preparation of phosgene 3 and the separation of phosgene 4 by cooling to about 5° C. The aqueous HCl and also the CO₂ are recycled as in FIG. 1.

FIG. 10 shows a possible process for a combined hydrochloric acid-CO₂ electrolysis with intermediate hydrochloric acid separation. The sequence in FIG. 10 corresponds to that in FIG. 9, with use of HCl in the electrolysis rather than MCl as in FIG. 5, with the corresponding results as in FIG. 5.

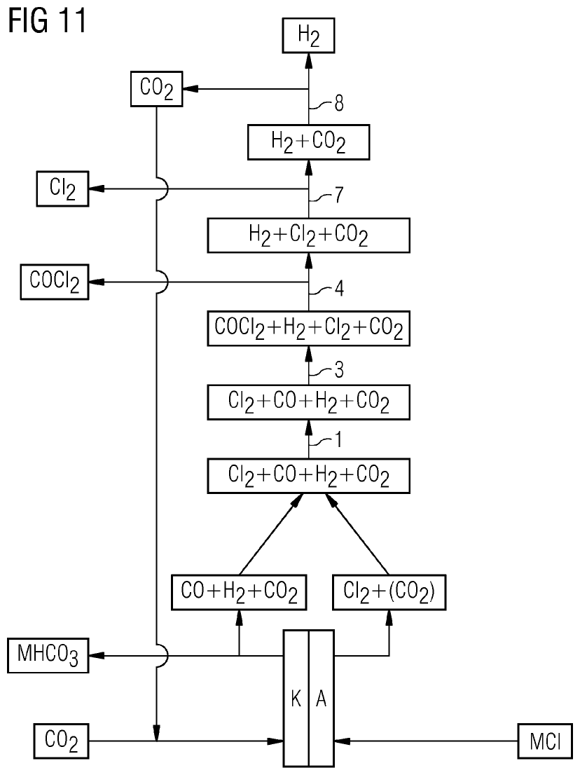

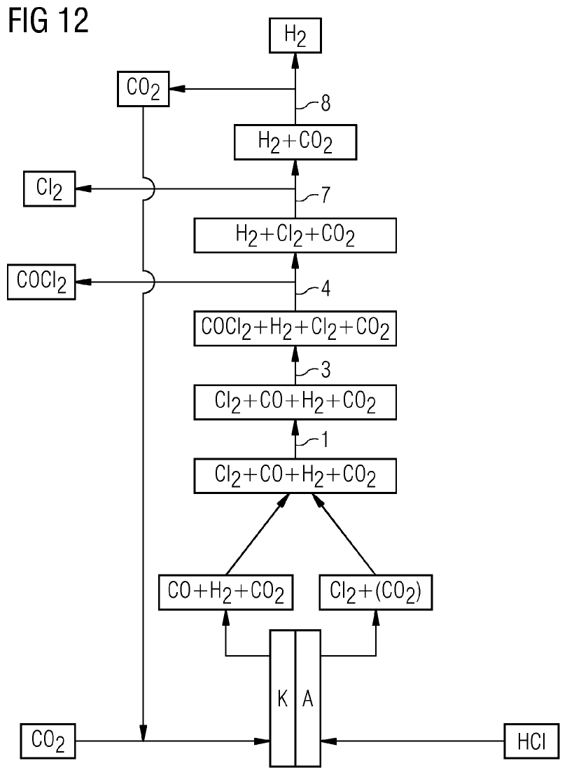

FIG. 11 and FIG. 12 show variants of the process of the invention in which the chlorine/oxyhydrogen gas reaction is omitted, which necessitates a modification of the later separation process.

FIG. 11 shows a possible process for a combined alkali metal chloride-CO₂ electrolysis with distillative separation of chlorine. In this case, there is first electrolysis as in FIG. 1, drying (step 1), preparation of phosgene (step 3) and separation thereof (step 4) so as to leave a gas mixture comprising H₂, Cl₂ and CO₂. Cl₂ can be separated therefrom by a cryodistillation 7 at −35° C., for example, before CO₂ is separated by a CO₂ separation 8 and recycled. The remaining H₂ can be used further in some other way.

FIG. 12 shows a possible process for a combined hydrochloric acid-CO₂ electrolysis with distillative separation of chlorine, which corresponds to that of FIG. 11 except that—as in FIG. 5—HCl is used in the electrolysis rather than MCl.

In a second aspect, an apparatus for preparation of phosgene is disclosed, comprising: —at least one electrolysis cell for CO₂ conversion to CO, comprising a cathode space comprising a cathode for CO₂ conversion to a first gaseous product comprising CO, said cathode being set up to convert CO₂ to a first gaseous product comprising CO, and an anode space comprising an anode for conversion of HCl and/or metal chloride, where the HCl and/or the metal chloride are optionally in the form of a solution, to a second gaseous product comprising at least Cl₂, said anode being set up to convert HCl and/or a metal chloride, where the HCl and/or the metal chloride are optionally in the form of a solution, to a second gaseous product comprising at least Cl₂, —at least one first feed apparatus for CO₂ which is connected to the cathode space of the electrolysis cell for CO₂ conversion to CO and is set up to feed CO₂ to the cathode space of the electrolysis cell for CO₂ conversion to CO, —at least one second feed apparatus for HCl and/or a metal chloride, where the HCl or the metal chloride is optionally in the form of a solution, which is connected to the anode space of the electrolysis cell for CO₂ conversion to CO and is set up to feed HCl and/or a metal chloride, where the HCl or the metal chloride is optionally in the form of a solution, to the anode space of the electrolysis cell for CO₂ conversion to CO, —at least one first removal apparatus for the first gaseous product which is connected to the cathode space of the electrolysis cell for CO₂ conversion to CO and is set up to remove the first gaseous product from the cathode space of the electrolysis cell for CO₂ conversion to CO, —at least one second removal apparatus for the second gaseous product which is connected to the anode space of the electrolysis cell for CO₂ conversion to CO and is set up to remove the second gaseous product from the anode space of the electrolysis cell for CO₂ conversion to CO, —at least one first combining apparatus which is connected to the first removal apparatus and the second removal apparatus and is set up to combine the first gaseous product and the second gaseous product in order to produce a product gas mixture; —at least one first reactor which is connected to the first combining apparatus and is set up to react the product gas mixture at least to give phosgene, in order to prepare a reacted product gas mixture; and —at least one first separation apparatus which is connected to the first reactor and is set up to separate phosgene from the reacted product gas mixture;

or comprising—at least one electrolysis cell for CO₂ conversion to CO, comprising a cathode space comprising a cathode for CO₂ conversion to a first gaseous product comprising CO, said cathode being set up to convert CO₂ to a first gaseous product comprising CO, and an anode space comprising an anode for conversion of HCl and/or metal chloride, where the HCl and/or the metal chloride are optionally in the form of a solution, to a second gaseous product comprising at least Cl₂, said anode being set up to convert HCl and/or a metal chloride, where the HCl and/or the metal chloride are optionally in the form of a solution, to a second gaseous product comprising at least Cl₂, —at least one first feed apparatus for CO₂ which is connected to the cathode space of the electrolysis cell for CO₂ conversion to CO and is set up to feed CO₂ to the cathode space of the electrolysis cell for CO₂ conversion to CO, —at least one second feed apparatus for HCl and/or a metal chloride, where the HCl or the metal chloride is optionally in the form of a solution, which is connected to the anode space of the electrolysis cell for CO₂ conversion to CO and is set up to feed HCl and/or a metal chloride, where the HCl or the metal chloride is optionally in the form of a solution, to the anode space of the electrolysis cell for CO₂ conversion to CO, —at least one common removal apparatus for the first gaseous product and the second gaseous product which is connected to the electrolysis cell for CO₂ conversion to CO and is set up to remove the first gaseous product and the second gaseous product from the electrolysis cell for CO₂ conversion to CO, —at least one first reactor which is connected to the common removal apparatus and is set up to react the product gas mixture at least to give phosgene, in order to prepare a reacted product gas mixture; and —at least one first separation apparatus which is connected to the first reactor and is set up to separate phosgene from the reacted product gas mixture.

The apparatus of the invention can especially be used to perform the process of the invention.

In particular embodiments, the present invention relates to an apparatus for preparation of phosgene, comprising: —at least one electrolysis cell for CO₂ conversion to CO, comprising a cathode space comprising a cathode for CO₂ conversion to a first gaseous product comprising CO, said cathode being set up to convert CO₂ to a first gaseous product comprising CO, and an anode space comprising an anode for conversion of HCl and/or metal chloride, where the HCl and/or the metal chloride are optionally in the form of a solution, to a second gaseous product comprising at least Cl₂, said anode being set up to convert HCl and/or a metal chloride, where the HCl and/or the metal chloride are optionally in the form of a solution, to a second gaseous product comprising at least Cl₂, —at least one first feed apparatus for CO₂ which is connected to the cathode space of the electrolysis cell for CO₂ conversion to CO and is set up to feed CO₂ to the cathode space of the electrolysis cell for CO₂ conversion to CO, —at least one second feed apparatus for HCl and/or a metal chloride, where the HCl or the metal chloride is optionally in the form of a solution, which is connected to the anode space of the electrolysis cell for CO₂ conversion to CO and is set up to feed HCl and/or a metal chloride, where the HCl or the metal chloride is optionally in the form of a solution, to the anode space of the electrolysis cell for CO₂ conversion to CO, —at least one first removal apparatus for the first gaseous product which is connected to the cathode space of the electrolysis cell for CO₂ conversion to CO and is set up to remove the first gaseous product from the cathode space of the electrolysis cell for CO₂ conversion to CO, —at least one second removal apparatus for the second gaseous product which is connected to the anode space of the electrolysis cell for CO₂ conversion to CO and is set up to remove the second gaseous product from the anode space of the electrolysis cell for CO₂ conversion to CO, —at least one first combining apparatus which is connected to the first removal apparatus and the second removal apparatus and is set up to combine the first gaseous product and the second gaseous product in order to produce a product gas mixture; —at least one first reactor which is connected to the first combining apparatus and is set up to react the product gas mixture at least to give phosgene, in order to prepare a reacted product gas mixture; and —at least one first separation apparatus which is connected to the first reactor and is set up to separate phosgene from the reacted product gas mixture.

The at least one electrolysis cell, for example an electrochemical apparatus for combined production of CO and Cl₂ from CO₂ and HCl/metal, especially alkali metal, chlorides is not particularly restricted, provided that it is suitable for the purpose. It comprises at least one anode and one cathode, and may additionally comprise at least one membrane and/or one diaphragm.

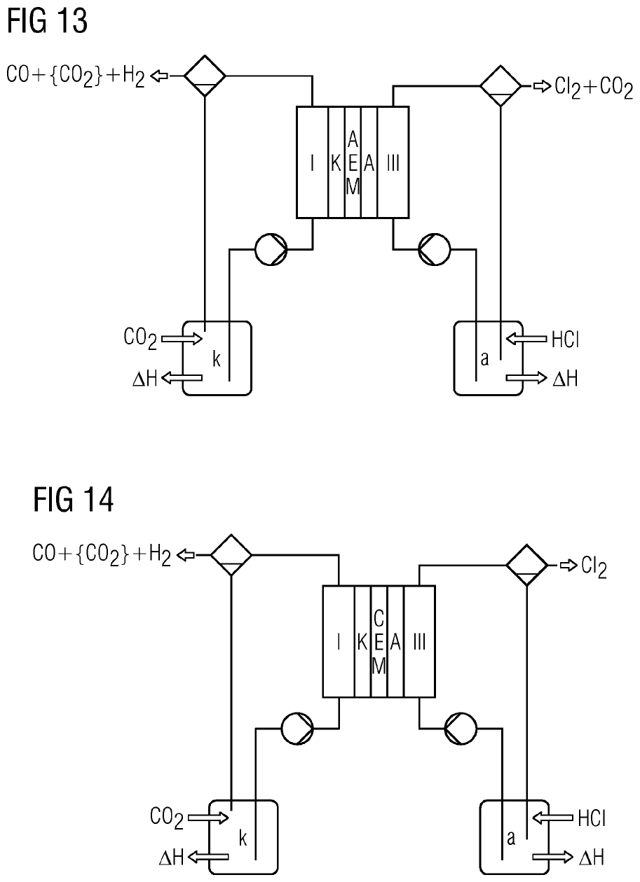

FIGS. 13 to 19 hereinafter show embodiments in illustrative and schematic form. The part that follows especially shows an illustration of electrolysis cell concepts compatible with the process of the invention.

The following abbreviations are used in FIGS. 13 to 19:

K: cathode

A: anode

I: cathode space

III: anode space

AEM: anion exchange membrane

CEM: cation/proton exchange membrane

DF: diaphragm

k: catholyte

a: anolyte

s: electrolyte as salt bridge between anode space and cathode space

R: recycle line

The other symbols in the drawings are standard fluidic connection symbols.

Anode and cathode in this case are not particularly restricted, provided that the cathode is suitable for electrochemical conversion of gaseous CO₂ to CO and the anode is suitable for electrochemical oxidation of chloride to chlorine in solutions of hydrogen chloride or metal chlorides, especially alkali metal chlorides.

FIG. 13 and FIG. 14 show membrane-electrode assemblies (MEA) or MEA cells according to the model of fuel cells or PEM (proton exchange membrane) electrolyzers with anion exchange membrane in FIG. 13 and with cation/proton exchange membrane in FIG. 14. A structure corresponding to FIG. 13 can also be inferred, for example, from US 2016/0251755 A1 and U.S. Pat. No. 9,481,939. As shown in FIG. 13, however, when the AEM is used (with the hydrogen carbonate charge carrier), there can be release of CO₂ (up to ⅔ of the overall feed). This can be problematic especially in a non-combined CO₂ electrolysis since a 1:4 mixture of O₂ and CO₂ thus formed at the anode is no longer utilizable. Even in the case of an electrolysis combined with Cl₂, as in the present context, this could be a problem. Since the gas flows of anode and cathode in the process shown here, however, are being combined in any case, CO₂ release at the anode is unproblematic.

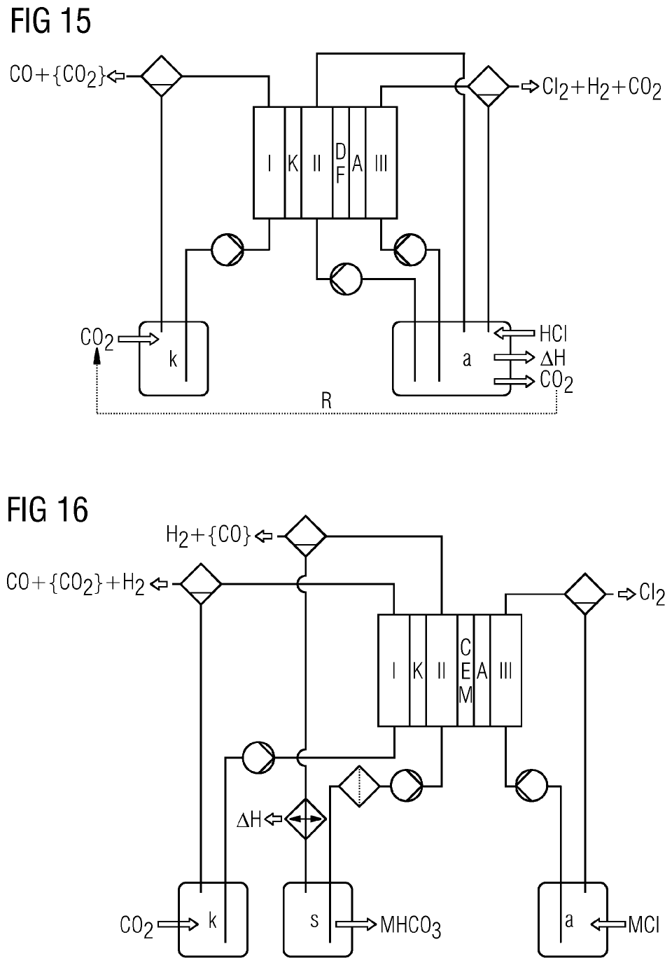

FIG. 15 shows a cell with a diaphragm according to the model of alkali electrolysis with a simple diaphragm, with a space II present here as mediator on the cathode side, in which an electrolyte comes into contact with the cathode K and hence establishes electrical contact with the anode space III.

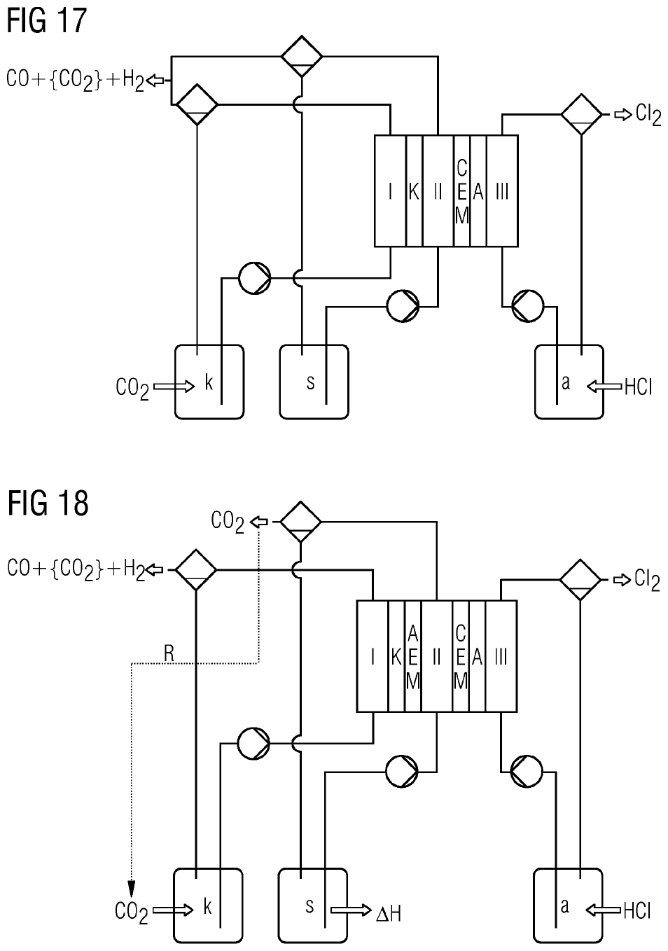

FIG. 16 and FIG. 17 shows cells with a simple membrane according to the model of chlor-alkali electrolysis. FIG. 16 here shows an arrangement with a CEM for alkali metal chlorides as reagent on the anode side, and FIG. 17 an arrangement with a CEM for hydrochloric acid as reagent on the anode side.

Adaptation of a diaphragm structure for alkali metal chlorides would also be conceivable.

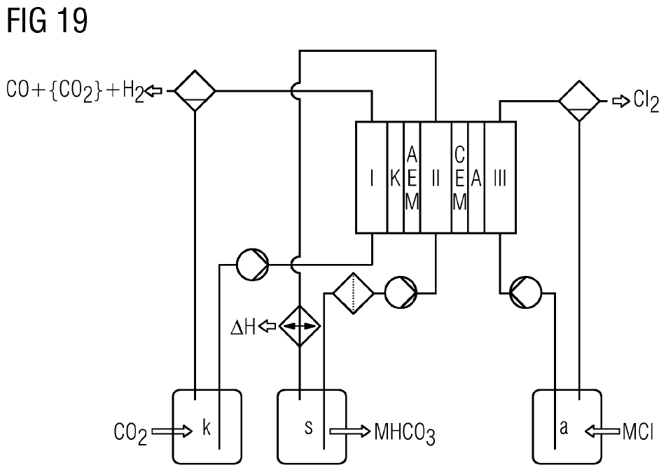

FIG. 18 and FIG. 19 show double-membrane cells in which a salt bridge space II is provided between two membranes, which serves as mediator between anode space III and cathode space I and can further reduce or prevent passage of gas and/or mass transfer into the respective spaces.

For the conversion of CO₂ to CO and of HCl and/or metal chloride to Cl₂, the respective electrode material is not particularly restricted, provided that the respective reaction can proceed correspondingly. In the at least one electrolysis cell, anode and cathode are thus not particularly restricted, provided that the cathode is suitable for electrochemical conversion of gaseous CO₂ to CO, and the anode is suitable for electrochemical oxidation of chloride to chlorine, especially in solutions of hydrogen chloride or metal chlorides such as alkali metal chlorides, especially aqueous solutions. In particular embodiments, the first gaseous product and/or the second gaseous product is prepared with a gas diffusion electrode.

Possible embodiments of a cathode are, for example, a silver- and/or gold-based gas diffusion electrode, a gas diffusion electrode of a composite of silver and/or gold with an anion exchange membrane (AEM), a silver particle-laden carbon gas diffusion layer, an open sheetlike structure made of silver and/or gold, a silver- and/or gold-based coating on an AEM, cation exchange membrane (CEM) or a diaphragm, etc.

Possible embodiments of the anode are, for example, an open sheetlike structure composed, for example, of titanium coated with a catalyst, a catalyst-laden or -impregnated carbon gas diffusion layer, a catalyst coating on an AEM or CEM or a diaphragm, with examples of suitable catalysts including IrOₓ, RuO₂, or mixed oxides thereof, optionally also with addition of TiO₂, etc.

In particular embodiments, the cathode and/or anode of the electrolysis cell is set up for CO₂ conversion to CO as gas diffusion electrode.

Within the at least one electrolysis cell, it is possible to use at least one electrolyte. When a cathode space and an anode space or further spaces are separated by at least one membrane and/or one diaphragm, it is also possible for multiple electrolytes to be present in the at least one electrolysis cell. These may be the same or different and are not particularly restricted. In particular embodiments, one or more aqueous electrolytes are used. These may optionally include a conductive salt which is not particularly restricted. Especially on the anode side, if a metal chloride is used there in the electrolysis, this can also serve as conductive salt. Alternatively or additionally, it is of course also possible for HCl to be present in the form of hydrochloric acid on the anode side, but this may also be supplied as gas, for example in a gas diffusion electrode. Irrespective of this, it may also be advisable in the case of HCl or metal chloride solution to design the anode as a gas diffusion electrode in order to prevent gas bubbles in the electrolyte.

If at least one membrane and/or one diaphragm is present, these are not particularly restricted.

In addition, the at least one first feed apparatus, the at least one second feed apparatus, the at least one first removal apparatus, the at least one second removal apparatus, and the at least one common removal apparatus are not particularly restricted, provided that they are suitable for conveying a substance present therein and/or a substance mixture, for example CO₂, HCl and/or metal chloride, for example in solution form, or product gases, i.e., for example, have been produced from a suitable material which is otherwise not particularly restricted. It is also optionally possible to provide suitable pump apparatuses, valves, etc.

In particular embodiments, the at least one electrolysis cell for CO₂ conversion to CO comprises the at least one first removal apparatus and the at least one second removal apparatus, advantageously with separation of the cathode space and the anode space in the electrolysis cell for CO₂ conversion to CO by at least one membrane and/or one diaphragm.

In addition, the at least one first combining apparatus is not particularly restricted, provided that it can contain the product gas mixture. In particular embodiments, the at least one first combining apparatus enables mixing of the gaseous products.

The at least one first reactor is not particularly restricted either, provided that it is suitable for preparation of phosgene, and may comprise, for example, a suitable catalyst, for example activated carbon, which may be provided in a suitable manner.

The at least one separation apparatus for separation of phosgene is not particularly restricted either and may comprise, for example, a cooling apparatus that can cool reacted product gas mixture to 7° C. or lower, advantageously 5° C. or lower, for example 0° C. or lower. In particular embodiments, the cooling apparatus as separation apparatus for separation of phosgene cools the reacted product gas mixture to −30° C. or higher, advantageously −20° C. or higher, further advantageously −10° C. or higher. In addition, the separation apparatus for separation of phosgene may comprise, for example, a third removal apparatus for phosgene which is set up to remove phosgene from the at least one separation apparatus for separation of phosgene.

In addition, at least one drier for drying the product gas mixture and/or the first and/or second gaseous product may be provided, which is not particularly restricted.

In particular embodiments, the apparatus of the invention further comprises a second reactor for preparation of HCl which is set up to prepare HCl from the product gas mixture, wherein the second reactor is connected to the first reactor and is upstream or downstream of the first reactor in flow direction of the product gas mixture. Alternatively or additionally, it is also possible that the first reactor is set up to additionally prepare HCl from the product gas mixture. The second reactor for preparation of HCl is not particularly restricted here.

In this regard, it should be noted that the apparatus of the invention may also comprise at least one heater and/or at least one cooler, for example for cooling the second reactor, in order, if appropriate, to be able to control the reactions in the preparation of phosgene and optionally HCl.

In particular embodiments, the apparatus of the invention further comprises a gas scrubbing apparatus for scrubbing out HCl which is connected to the second reactor or the first reactor and is set up to scrub HCl out of the product gas mixture or the reacted product gas mixture, and which is additionally not particularly restricted. In this case, a first recycling device may be provided for HCl, which is set up to recycle the HCl from the gas scrubbing apparatus to the second feed apparatus.

In particular embodiments, the apparatus of the invention further comprises a device for freezing out CO₂ which is set up to separate CO₂ from the reacted product gas mixture by cryoadsorption or freezing-out, and which is likewise also not particularly restricted. In this case, a second recycling device may also be provided for CO₂, which is also set up to recycle the CO₂ from a device for freezing-out CO₂ to the first feed apparatus.

In particular embodiments, the second reactor and the gas scrubbing apparatus are upstream of the first reactor in flow direction of the product gas mixture.

In particular embodiments, the apparatus of the invention further comprises a device for cryodistillation which is set up to separate Cl₂ from the reacted product gas mixture by cryodistillation.

Also described is a process (as process variant G) for preparation of phosgene, wherein i) a first gaseous product comprising CO is prepared from CO₂ on the cathode side in a first electrolysis cell for CO₂ conversion to CO, and a second gaseous product comprising at least Cl₂ is prepared from HCl and/or a metal chloride, where the HCl and/or the metal chloride are optionally in the form of a solution, on the anode side in a second electrolysis cell; ii) the first gaseous product and the second gaseous product are combined in order to produce a product gas mixture; iii) the product gas mixture is reacted at least to give phosgene, in order to prepare a reacted product gas mixture; and iv) phosgene is separated from the reacted product gas mixture.

The corresponding process steps correspond to those of the process of the invention in the first aspect, except that CO and Cl₂ are prepared in separate electrolysis cells.

Also described in this connection is an apparatus for preparation of phosgene, comprising: —at least one first electrolysis cell for CO₂ conversion to CO, comprising a cathode space comprising a cathode for CO₂ conversion to a first gaseous product comprising CO, said cathode being set up to convert CO₂ to a first gaseous product comprising CO, —at least one second electrolysis cell comprising an anode space comprising an anode for conversion of HCl and/or metal chloride, where the HCl and/or the metal chloride are optionally in the form of a solution, to a second gaseous product comprising at least Cl₂, said anode being set up to convert HCl and/or a metal chloride, where the HCl and/or the metal chloride are optionally in the form of a solution, to a second gaseous product comprising at least Cl₂, —at least one first feed apparatus for CO₂ which is connected to the cathode space of the electrolysis cell for CO₂ conversion to CO and is set up to feed CO₂ to the cathode space of the electrolysis cell for CO₂ conversion to CO, —at least one second feed apparatus for HCl and/or a metal chloride, where the HCl or the metal chloride is optionally in the form of a solution, which is connected to the anode space of the electrolysis cell for CO₂ conversion to CO and is set up to feed HCl and/or a metal chloride, where the HCl or the metal chloride is optionally in the form of a solution, to the anode space of the electrolysis cell for CO₂ conversion to CO, —at least one first removal apparatus for the first gaseous product which is connected to the cathode space of the electrolysis cell for CO₂ conversion to CO and is set up to remove the first gaseous product from the cathode space of the electrolysis cell for CO₂ conversion to CO, —at least one second removal apparatus for the second gaseous product which is connected to the anode space of the electrolysis cell for CO₂ conversion to CO and is set up to remove the second gaseous product from the anode space of the electrolysis cell for CO₂ conversion to CO, —at least one first combining apparatus which is connected to the first removal apparatus and the second removal apparatus and is set up to combine the first gaseous product and the second gaseous product in order to produce a product gas mixture; —at least one first reactor which is connected to the first combining apparatus and is set up to react the product gas mixture at least to give phosgene, in order to prepare a reacted product gas mixture; and —at least one first separation apparatus which is connected to the first reactor and is set up to separate phosgene from the reacted product gas mixture.

This apparatus can be used to perform the process according to process variant G. The first and second electrolysis cells here are not particularly restricted and may correspond, for example, to those of the electrolysis cell of the apparatus of the invention, with no preparation of Cl₂ on the anode side in the first electrolysis cell and no CO on the cathode side in the second electrolysis cell.

The above embodiments, configurations and developments can, if viable, be combined with one another as desired. Further possible configurations, developments and implementations of the invention also include combinations that have not been mentioned explicitly of features of the invention that have been described above or are described hereinafter with regard to the working examples. More particularly, the person skilled in the art will also add individual aspects to the respective basic form of the present invention as improvements or supplementations.

The invention is elucidated in further detail hereinafter with reference to various examples. However, the invention is not restricted to these examples.

### EXAMPLES

### Example 1

An illustrative process of the invention takes place according to FIG. 1. In an electrolysis cell with a diaphragm, there is a silver gas diffusion electrode on the cathode side, which is supplied with CO₂ and which dips into an electrolyte composed of aqueous HCl. On the anode side, as the anode, there is an open sheetlike structure made of titanium coated with a ruthenium catalyst. The anode is supplied with aqueous HCl.

A first gaseous product comprising CO, H₂ and CO₂ is formed on the cathode side, and a second gaseous product comprising Cl₂ and CO₂ on the anode side. The two gaseous products are each removed from the respective electrode space and combined in a gas mixer. The product gas mixture is dried and then a chlorine/oxyhydrogen gas reaction is initiated by combustion. Thereafter, the product gas mixture in which Cl₂, CO, CO₂ and HCl are present is guided through a first reactor containing activated carbon, wherein Cl₂ and CO are allowed to react to give phosgene. The reacted product gas mixture is subsequently passed through a cooling apparatus at 5° C., and phosgene is separated off in liquid form. HCl is separated from the remaining gas mixture of HCl and CO₂ in the form of hydrochloric acid by gas scrubbing with water, and recycled to the feed for HCl on the anode side of the electrolysis cell. The remaining CO₂ is recycled to the silver gas diffusion electrode for supply of CO₂.

1. A process for preparing phosgene, comprising:
i) preparing a first gaseous product comprising CO from CO₂ on the cathode side in at least one electrolysis cell for CO₂ conversion to CO, and preparing a second gaseous product comprising at least Cl₂ from HCl and/or a metal chloride, where the HCl and/or the metal chloride are optionally in the form of a solution, on the anode side;
ii) combining the first gaseous product and the second gaseous product in order to produce a product gas mixture;
iii) reacting the product gas mixture at least to give phosgene, in order to prepare a reacted product gas mixture; and
iv) separating phosgene from the reacted product gas mixture.

2. The process as claimed in claim 1,
wherein HCl is additionally prepared from the product gas mixture, wherein the HCl is prepared before, with or after the preparation of the phosgene.

3. The process as claimed in claim 2,
wherein HCl is scrubbed out of the product gas mixture or the reacted product gas mixture and/or CO₂ is separated from the reacted product gas mixture by cryoadsorption or freezing-out.

4. The process as claimed in claim 3,
wherein the preparation of HCl and the separation of HCl precede the preparation of phosgene.

5. The process as claimed in claim 1,
wherein the electrolysis cell for CO₂ conversion to CO has a cathode space and an anode space separated by at least one membrane and/or one diaphragm.

6. The process as claimed in claim 1,
wherein the first gaseous product and/or the second gaseous product is produced with a gas diffusion electrode.

7. The process as claimed in claim 1,
wherein the phosgene is separated at a temperature of 7° C. or less.

8. The process as claimed in claim 1,
wherein Cl₂ is separated from the reacted product gas mixture by cryodistillation.

9. An apparatus for preparation of phosgene, comprising:
at least one electrolysis cell for CO₂ conversion to CO, comprising a cathode space comprising a cathode for CO₂ conversion to a first gaseous product comprising CO, said cathode being set up to convert CO₂ to a first gaseous product comprising CO, and an anode space comprising an anode for conversion of HCl and/or metal chloride, where the HCl and/or the metal chloride are optionally in the form of a solution, to a second gaseous product comprising at least Cl₂, said anode being set up to convert HCl and/or a metal chloride, where the HCl and/or the metal chloride are optionally in the form of a solution, to a second gaseous product comprising at least Cl₂,
at least one first feed apparatus for CO₂ which is connected to the cathode space of the electrolysis cell for CO₂ conversion to CO and is set up to feed CO₂ to the cathode space of the electrolysis cell for CO₂ conversion to CO,
at least one second feed apparatus for HCl and/or a metal chloride, where the HCl or the metal chloride is optionally in the form of a solution, which is connected to the anode space of the electrolysis cell for CO₂ conversion to CO and is set up to feed HCl and/or a metal chloride, where the HCl or the metal chloride is optionally in the form of a solution, to the anode space of the electrolysis cell for CO₂ conversion to CO,
at least one first removal apparatus for the first gaseous product which is connected to the cathode space of the electrolysis cell for CO₂ conversion to CO and is set up to remove the first gaseous product from the cathode space of the electrolysis cell for CO₂ conversion to CO,
at least one second removal apparatus for the second gaseous product which is connected to the anode space of the electrolysis cell for CO₂ conversion to CO and is set up to remove the second gaseous product from the anode space of the electrolysis cell for CO₂ conversion to CO,
at least one first combining apparatus which is connected to the first removal apparatus and the second removal apparatus and is set up to combine the first gaseous product and the second gaseous product in order to produce a product gas mixture;
at least one first reactor which is connected to the first combining apparatus and is set up to react the product gas mixture at least to give phosgene, in order to prepare a reacted product gas mixture; and
at least one first separation apparatus which is connected to the first reactor and is set up to separate phosgene from the reacted product gas mixture;
or comprising
at least one electrolysis cell for CO₂ conversion to CO, comprising a cathode space comprising a cathode for CO₂ conversion to a first gaseous product comprising CO, said cathode being set up to convert CO₂ to a first gaseous product comprising CO, and an anode space comprising an anode for conversion of HCl and/or metal chloride, where the HCl and/or the metal chloride are optionally in the form of a solution, to a second gaseous product comprising at least Cl₂, said anode being set up to convert HCl and/or a metal chloride, where the HCl and/or the metal chloride are optionally in the form of a solution, to a second gaseous product comprising at least Cl₂,
at least one first feed apparatus for CO₂ which is connected to the cathode space of the electrolysis cell for CO₂ conversion to CO and is set up to feed CO₂ to the cathode space of the electrolysis cell for CO₂ conversion to CO,
at least one second feed apparatus for HCl and/or a metal chloride, where the HCl or the metal chloride is optionally in the form of a solution, which is connected to the anode space of the electrolysis cell for CO₂ conversion to CO and is set up to feed HCl and/or a metal chloride, where the HCl or the metal chloride is optionally in the form of a solution, to the anode space of the electrolysis cell for CO₂ conversion to CO,
at least one common removal apparatus for the first gaseous product and the second gaseous product which is connected to the electrolysis cell for CO₂ conversion to CO and is set up to remove the first gaseous product and the second gaseous product from the electrolysis cell for CO₂ conversion to CO,
at least one first reactor which is connected to the common removal apparatus and is set up to react the product gas mixture at least to give phosgene, in order to prepare a reacted product gas mixture; and
at least one first separation apparatus which is connected to the first reactor and is set up to separate phosgene from the reacted product gas mixture.

10. The apparatus as claimed in claim 9, further comprising
a second reactor for preparation of HCl which is set up to prepare HCl from the product gas mixture, wherein the second reactor is connected to the first reactor and is upstream or downstream of the first reactor in flow direction of the product gas mixture, or wherein the first reactor is set up to additionally prepare HCl from the product gas mixture.

11. The apparatus as claimed in claim 10, further comprising:
a gas scrubbing apparatus for scrubbing out HCl which is connected to the second reactor or the first reactor and is set up to scrub HCl out of the product gas mixture or the reacted product gas mixture, and/or further comprising a device for freezing out CO₂ which is set up to separate CO₂ from the reacted product gas mixture by cryoadsorption or freezing-out.

12. The apparatus as claimed in claim 11,
wherein the second reactor and the gas scrubbing apparatus are upstream of the first reactor in flow direction of the product gas mixture.

13. The apparatus as claimed in claim 9,
wherein the at least one electrolysis cell for CO₂ conversion to CO comprises the at least one first removal apparatus and the at least one second removal apparatus, and the cathode space and the anode space in the electrolysis cell for CO₂ conversion to CO is separated by at least one membrane and/or one diaphragm.

14. The apparatus as claimed in claim 9,
wherein the cathode and/or anode of the electrolysis cell for CO₂ conversion to CO is designed as a gas diffusion electrode.

15. The apparatus as claimed in claim 9, further comprising:
a device for cryodistillation which is set up to separate Cl₂ from the reacted product gas mixture by cryodistillation.

16. The process as claimed in claim 7,
wherein the phosgene is separated at a temperature of 5° C. or less.
